(19) United States
(12) Patent Application Publication
(10) Pub. No.: US 2017/0052097 A1
(43) Pub. Date: Feb. 23, 2017

(54) SHAPE-SENSING SYSTEM HAVING SENSOR STRIP AND DEFORMABLE OBJECT

(71) Applicants: MediaTek Inc., Hsin-Chu (TW); National Taiwan University, Taipei (TW)

(72) Inventors: Bing-Yu CHEN, Taipei (TW); Li-Wei CHAN, New Taipei City (TW); Rong-Hao LIANG, Taipei City (TW); Chin-yu CHIEN, Taipei City (TW)

(21) Appl. No.: 14/957,952

(22) Filed: Dec. 3, 2015

Related U.S. Application Data
(60) Provisional application No. 62/205,801, filed on Aug. 17, 2015.

(51) Int. Cl. G01N 3/20

(52) U.S. Cl. CPC G01N 3/20

(57) ABSTRACT

A shape-sensing system includes a deformable object, a strip substrate, and a plurality of bend sensors. The deformable object is configured to deform when a first force is exerted on the deformable object. The strip substrate is installed in the shape-sensing system such that the strip substrate deforms in response to deformation of the deformable object. The plurality of bend sensors is fixedly attached to a surface of the strip substrate at different respective locations for generating respective values in response to deformation of the strip substrate. The respective values are used for obtaining tracked deformation of the deformable object.

This application claims the benefit of U.S. Provisional Application No. 62/205,801, filed on Aug. 17, 2015, the entirety of which is incorporated by reference herein.

### BACKGROUND OF THE INVENTION

Field of the Invention

The invention relates generally to an apparatus for shape-sensing, and more particularly, to an apparatus for tracking the deformation of a deformable object using bend sensors attached to a strip substrate.

Description of the Related Art

Bend sensors generally refer to sensors that can be used to detect deformations of physical bodies. Take strain gauge for example: A strain gauge can be implemented with metal wired formed by a resistor of a certain resistance. When an external force, such as a pulling force, pressure, tension, or another force, acts on the metal wire and causes the length of the metal wire to change, the change of its resistance and the change of its length are directly proportional. Therefore, we can calculate the strength or the level of deformation according to the change of its resistance.

With the advent of 3D fabrication tools such as 3D printers, one can design and conveniently fabricate physical objects. For enhancing user experience, a deformable object fabricated by a 3D fabrication tool is a promising candidate. In tracking deformations of a deformable object, bend sensors may be exploited. For integrating bend sensors with deformable objects, conventional methods either fail to produce a high accuracy of tracked deformation or require a complex structural design. Thus, there's a strong need to devise an easily installed shape-sensing system that provides excellent user interactivity.

### BRIEF SUMMARY OF THE INVENTION

A shape-sensing system is provided. An exemplary embodiment of the shape-sensing system comprises a deformable object, a strip substrate, and a plurality of bend sensors. The deformable object is configured to deform when a first force is exerted on the deformable object. The strip substrate is installed in the shape-sensing system such that the strip substrate deforms in response to deformation of the deformable object. The plurality of bend sensors is fixedly attached to a surface of the strip substrate at different respective locations for generating respective values in response to deformation of the strip substrate. The respective values are used for obtaining tracked deformation of the deformable object.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIGS. 1A and 1B are block diagrams illustrating a shape-sensing system according to an embodiment of the invention;

FIG. 2 shows how shape construction is performed based on readings of bend sensors according to an embodiment of the invention;

FIGS. 3A, 3B and 3C give examples of applications of the shape-sensing system disclosed in FIGS. 1A and 1B according to another embodiment of the invention;

FIG. 4A shows a calibration module for bend sensors according to some embodiments of the invention;

FIG. 4B shows another calibration module for bend sensors according to another embodiment of the invention;

FIGS. 5A and 5B show another shape-sensing system according to some embodiments of the invention;

FIG. 5C shows a magnified view of some portions of the shape-sensing system of FIGS. 5A and 5B according to still another embodiment of the invention;

FIGS. 6A and 6B illustrate a gaming application of the shape-sensing system of FIGS. 5A and 5B according to some embodiments of the invention;

FIG. 7A shows an enlarged view of a portion of the shape-sensing system of FIGS. 5A and 5B according to another embodiment of the invention;

FIG. 7B shows readings collected from strain gauges installed in the shape-sensing system of FIGS. 5A and 5B according to still another embodiment of the invention; and

FIGS. 8A, 8B and 8C show alternative shape-sensing system designs according to some other embodiments of the invention.

### DETAILED DESCRIPTION OF THE INVENTION

Various embodiments of the invention are described with reference to the accompanying drawings in detail. The same reference numbers are used throughout the drawings to refer to the same or like components. These embodiments are made for the purpose of illustrating the general principles of the invention and should not be taken in a limiting sense. Detailed description of well-known functions and structures are omitted to avoid obscuring the subject matter of the invention.

It should be noted that different references to “an” or “one” embodiment in this disclosure are not necessarily to the same embodiment, and such references mean at least one. Furthermore, when a particular feature, structure, or characteristic is described in connection with an embodiment, it is submitted that it is within the knowledge of one skilled in the art to effect such feature, structure, or characteristic in connection with other embodiments whether or not explicitly described.

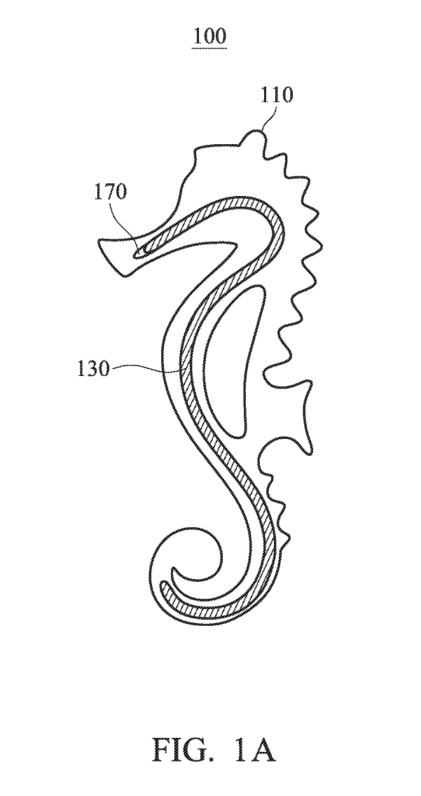

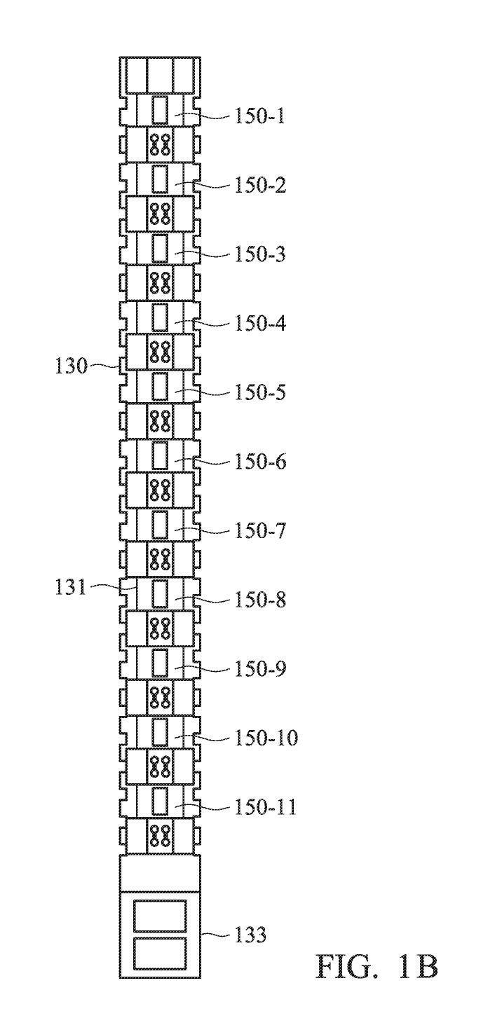

FIGS. 1A and 1B show a block diagram illustrating a shape-sensing system according to an embodiment of the invention. Referring to FIG. 1A, the shape-sensing system 100 comprises a deformable object 110, a strip substrate 130, and a plurality of bend sensors 150. The deformable object 110 is configured to deform when a first force is exerted on the deformable object 110. Here, the word deform should be construed in a broad sense to include any temporal or long-term changes on the overall appearance of the deformable object 110. By way of example, the deformable object 110 shown has the shape of a seahorse. However, this should not pose a limitation for the invention and the deformable object 110 might have any other shape depending on the application.

The strip substrate 130 is installed in the shape-sensing system 100 such that the strip substrate 130 deforms in response to deformation of the deformable object 110. As seen in FIG. 1A, the strip substrate 130 is embedded (i.e. filling into a body cavity 170 specifically reserved for the strip substrate 130) as a “spine” of the deformable object 110. So, when the deformable object is deformed, the strip substrate 130 deforms as well and the deformed shape of the strip substrate 130 to some extent matches the deformation of the deformable object 110.

Shown in FIG. 1B, the plurality of bend sensors 150 are fixedly attached to a surface of the strip substrate 130 at different respective locations. The plurality of bend sensors 150 are configured to generate respective values in response to deformation of the strip substrate 130. The respective values then can be used for obtaining tracked deformation of the deformable object 110. The bend sensors as used in this invention includes, but not limited to, any type of sensors capable of detecting bending such as strain gauges, optical fiber, pressure sensor, etc.

As can be seen more clearly in FIG. 1B, there are eleven bend sensors 150-1 through 150-11 (collectively referred to as bend sensors 150) distributed substantially uniformly along the strip substrate 130. Note that the number of bend sensors 150 may vary in different applications. The strip substrate 130 may be implemented by 3D-printed pliable filaments for ensuring structural integrity. Flexible printed circuit (FPC) may be used for fabricating the strip substrate 130 as well. These types of material enable ease of integrating the strip substrate 130 into the shape-sensing system 100. Each of the bend sensors 150 is capable of detecting a local bending of a portion of the strip substrate 130 that it is attached to. When the strip substrate 130 is deformed, each of the bend sensors 150 generates a respective value indicating the level of bending of the attached portion of the strip substrate 130. For instance, the respective value generated by the bend sensor 150-1 reflects how portions of the strip substrate 130 near the bend sensor 150-1 are bent. This respective value may represent a resistance value that increases or decreases as the level of bending increases. Based on the respective values, the shape of the strip substrate 130 can be reconstructed.

Note that, besides attaching the bend sensors 150 onto the strip substrate 130, a malleable material 131 may be attached to the strip substrate 130 to provide the strip substrate 130 with a shape-retaining capability. The malleable material 131 may be iron wires or other elastic materials that are not only bendable but also able to keep newly formed shapes after bending. By deploying the malleable material 131 on a surface of the strip substrate 130, the strip substrate 130 can keep its new form as well and a user may more easily manipulate the strip substrate to a desired shape.

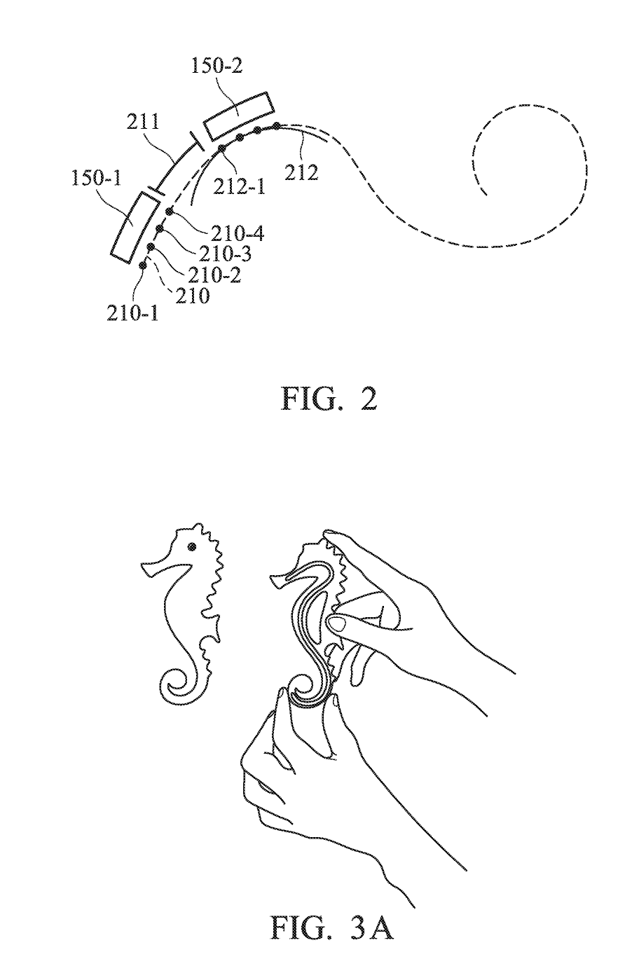

FIG. 2 illustrates shape construction based on values generated by bend sensors 150 according to another embodiment of the invention. Please refer to FIG. 2 accompanied with FIGS. 1A and 1B. The dashed curve illustrates the constructed shape of the strip substrate 130 according to values (or readings) generated by bend sensors 150. As the strip substrate 130 is deformed (e.g. in response to the deformation of the deformable object 110), 11 respective values are generated and these values may be collected wired or wirelessly by electrical circuits for processing below. Firstly, 11 discrete curves (only two discrete curves 210 and 212 are drawn for simplicity) can be obtained directly from the 11 respective values provided by the bend sensors 150 since each of the 11 respective values is indicative of a local curvature of the strip substrate 130 associated with one of the bend sensors 150. As indicated previously, each of the 11 discrete curves represents the shape of a portion of the strip substrate 130 where a particular bend sensor (e.g. 150-1) is attached nearby. The mapping between values provided by the bend sensors 150 and the corresponding curvatures may be established beforehand (e.g. through some calibration process that will be described in more detail later) for the purpose of generating the 11 discrete curves.

Secondly, each of the 11 discrete curves is replaced by some predefined number of points. For example, the discrete curve 210 is replaced by 4 uniformly distributed points 210-1 through 210-4 (i.e. these 4 points are used to describe the discrete curve 210). The points 210-1 through 210-4 can be picked based on the curvature of the discrete curve 210 obtained in the previous step. Repeating the replacement for the discrete curve 212 and the remaining discrete curves, there would be 44 (11×4) points for describing the shape of the strip substrate 130. Of course, one may use more or fewer points to represent any one of the curves in a tradeoff between shape-construction accuracy and computational resources. As the number of points used to replace the discrete curve 210 increases, the discrete curve 210 may be represented more accurately at the cost of using more computing resources.

Note that when attaching the bend sensors 150 to the strip substrate 130, there might be some gaps between two adjacent bend sensors and/or two adjacent segments of the strip substrate 130 (e.g. the gap 211). Directly connecting two end-points, for example the point 210-4 and the point 212-1, would result in an unsmooth curve representing the shape of the strip substrate 130. The gap 211 is estimated by linearly interpolating the curvatures of the discrete curves 210 and 211. Thus, according to one embodiment, one of the respective values generated by the bend sensors corresponds to a curvature crossing a plurality of points (e.g. 210-1 through 210-4) of a specific segment (e.g. 210) of the strip substrate 130, and the plurality of points (e.g. 210-4 and 212-1) associated with different curvatures corresponding to the respective values is interpolated to smoothly connect the spacing between the point 210-4 and the point 212-1 so that a smooth shape is constructed for the strip substrate 130 and the shape of the strip substrate 130 is estimated.

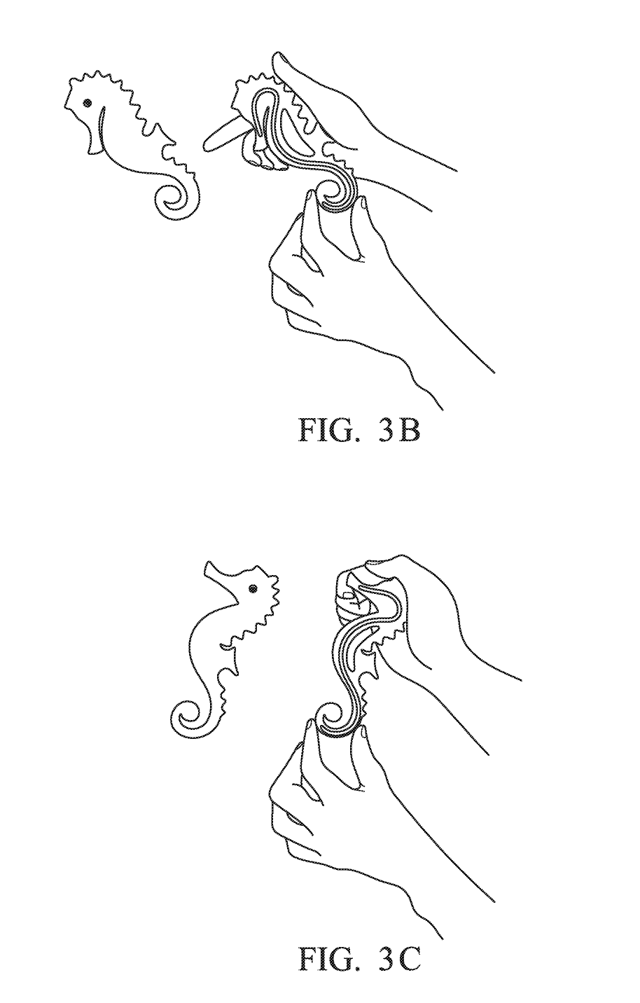

FIGS. 3A, 3B and 3C illustrate a puppetry storytelling application of the shape-sensing system 100 according to some embodiments. Please refer to FIG. 3A first. FIG. 3A shows two images of the deformable object 110; the image on the right (referred to as the right image) is the deformable object 110 held in the user's hands without bending, and the image on the left (referred to as the left image) is the deformable object 110 displayed via a display unit (not drawn) of an electronic device. As indicated earlier, the shape-sensing system 100 may further comprise a processing circuit (which will be described in more detail) that processes the respective values generated by the bend sensors 150 to obtain the shape of the deformable object 110. When the user wants the deformable object 110 (i.e. the seahorse) to look humble and shy, he or she bends its body so that the head of the seahorse looks downward (right image of FIG. 3B). The corresponding image would be displayed via the display unit of the electronic device (left image of FIG. 3B). When the user wants the seahorse to look confident and proud, he or she bends its body up so that the head of the seahorse looks upward (right image of FIG. 3C). The corresponding image would be displayed via the display unit of the electronic device (left image of FIG. 3C). Note that, in these examples, the user does not directly touch the strip substrate 130 and the force applied by the hands of the user is exerted on the strip substrate 130 indirectly through the deformable object 110.

Based on the aforementioned disclosure, some embodiments of the invention are described below. According to one embodiment, the shape-sensing system 100 comprises the deformable object 110, the strip substrate 130 and the plurality of bend sensors 150. The deformable object 110 is configured to deform when a first force is exerted (e.g. by the hands of the user in FIGS. 3A-3C) on the deformable object 110. The strip substrate 130 is installed in the shape-sensing system 100 such that the strip substrate 130 deforms in response to the deformation of the deformable object. The bend sensors 150 are fixedly attached to a surface of the strip substrate 130 at different respective locations, and are configured to generate respective values in response to the deformation of the strip substrate 130. The respective values are used for obtaining tracked deformation of the deformable object. According to one embodiment, the deformable object 100 is a hand-held device. In another embodiment, a force is indirectly exerted on the strip substrate 130 through the deformable object 110. In another embodiment, one of the respective values generated by the bend sensors 150 (e.g. the respective value generated by 150-2) is indicative of the local curvature (e.g. the discrete curve 212) of the strip substrate 130 associated with one of the bend sensors (e.g. the bend sensor 150-2). In still another embodiment, the deformable object 110 has a body cavity 170 and the strip substrate 130 is placed within the body cavity 170 so that deformation of the deformable object 110 can be represented by deformation of the strip substrate 130. In still another embodiment, the shape-sensing system 100 further comprises a malleable material that is attached to the strip substrate 130 to provide the strip substrate 130 with a shape-retaining capability.

Please refer back to FIGS. 1A and 1B. When using the bend sensors 150 to track deformation of the strip substrate 130, the respective values generated by the bend sensors 150 may be corrupted by environmental factors such as temperature, humidity, and so forth. Without some corrective techniques, the respective values may be too inaccurate for constructing shape of the strip substrate because of the environmental vulnerability of the bend sensors 150. To tackle this issue, one of the bend sensors 150 may be deployed as a dummy sensor; the dummy sensor itself is completely the same as the other bend sensors. The difference is that the dummy sensor is attached to a surface at a particular position (i.e. a first segment) of the strip substrate 130 and the first segment of the strip substrate 130 does not deform in response to deformation of the deformable object 110. The first segment of the strip substrate may be an end segment or another specific portion of the strip substrate 130 free from force exerted by a user. Since the first segment maintains its shape (or does not deform), the respective value obtained by the dummy sensor may well indicate the effect of the environmental factors. That is, without the environmental effects, the respective value of the dummy sensor may be 0. Hence, the respective value generated by the dummy sensor may be used for compensating for environmental effects on other respective values generated by bend sensors 150 (other than the dummy sensor). For example, when the dummy sensor reports a value VD, other respective values generated by the bend sensors 150 are each subtracted by VD and the shape-sensing system 100 uses the subtracted respective values to construct the shape of the strip substrate 130.

There are, however, different approaches to integrate the dummy sensor into the shape-sensing system 100. For example, the dummy sensor may be mounted on a printed circuit board (PCB), where the PCB is physically close to the bend sensors 150. Under this circumstance, the dummy sensor is not attached to a surface of the strip substrate 130.

As shown in FIG. 1B, the shape-sensing system 100 further comprises a processing circuit 133 used for obtaining tracked deformation of the deformable object 110 according to the respective values generated by the bend sensor 150. The processing circuit 133 may be fabricated on a printed circuit board (PCB) that may be coupled to an end of the strip substrate 130 through a wired connection. In this way, the processing circuit 133 receives the respective values from the bend sensors 150 through wired communication. Although not drawn, in another embodiment, the processing circuit 133 may be placed remotely with respect to the strip substrate 130 (and the deformable object 110); in this regard, the strip substrate 130 may be integrated with a wireless communication module. The wireless communication module receives the respective values obtained by the bend sensors 150 and then transmits the respective values to the processing circuit 133 wirelessly.

Once the processing circuit 133 receives the respective values generated by the bend sensors 150, the processing circuit 133 obtains the tracked deformation of the deformable object in two steps. The first step is to estimate the shape of the strip substrate 130 according to the respective values. An exemplary estimation approach is disclosed in the description pertinent to FIG. 2. After the shape of the strip substrate 130 is estimated, the tracked deformation of the deformable object 110 can be obtained by the processing circuit 133 according to the estimated shape of the strip substrate 130. This may not demand too much computing power from the processing circuit 133 since the shape of the strip substrate 130 may be highly correlated with the shape of the deformable object 110 as indicated in FIGS. 3A through 3C. The tracked deformation of the deformable object may be then transmitted (either wired or wirelessly) to an electronic device as an input to the electronic device. Then, corresponding images of the tracked deformation of the deformable object 110 may be displayed via a display unit of the electronic device to provide a user with an interactive experience.

Apart from the processing circuit 133, the shape-sensing system 100 may further comprise an inertial measurement unit (IMU) that is attached to an end of the strip substrate 130 for detecting the 3-dimensional (3D) orientation of the strip substrate 130. By incorporating the IMU into the shape-sensing system 100, the 3D orientation of the deformable object 110 may be acquired for some advanced applications. As IMU is known to be useful in 3D processing, the related description is omitted here for the sake of brevity.

Thus, the following reiterates some embodiments of the invention. According to one embodiment, one of the bend sensors 150 is a dummy sensor attached to a surface of a first segment of the strip substrate 130 and the first segment of the strip substrate 130 does not deform in response to deformation of the deformable object 110. In another embodiment, the respective value generated by the dummy sensor is used for compensating for environmental effects on other respective values (generated by other sensors). In another embodiment, the shape-sensing system 100 further comprises a processing circuit 133 that is configured for obtaining tracked deformation of the deformable object 110 according to the respective values (generated by the bend sensors 150), wherein the processing circuit 133 receives the respective values wired or wirelessly. In another embodiment, the processing circuit 133 estimates the shape of the strip substrate 130 according to the respective values and obtains the tracked deformation of the deformable object 110 according to estimated shape of the strip substrate 130. In still another embodiment, the processing circuit 133 transmits the tracked deformation of the deformable object to an electronic device as an input to the electronic device; and the images corresponding to the tracked deformation of the deformable object is displayed via a display unit of the electronic device.

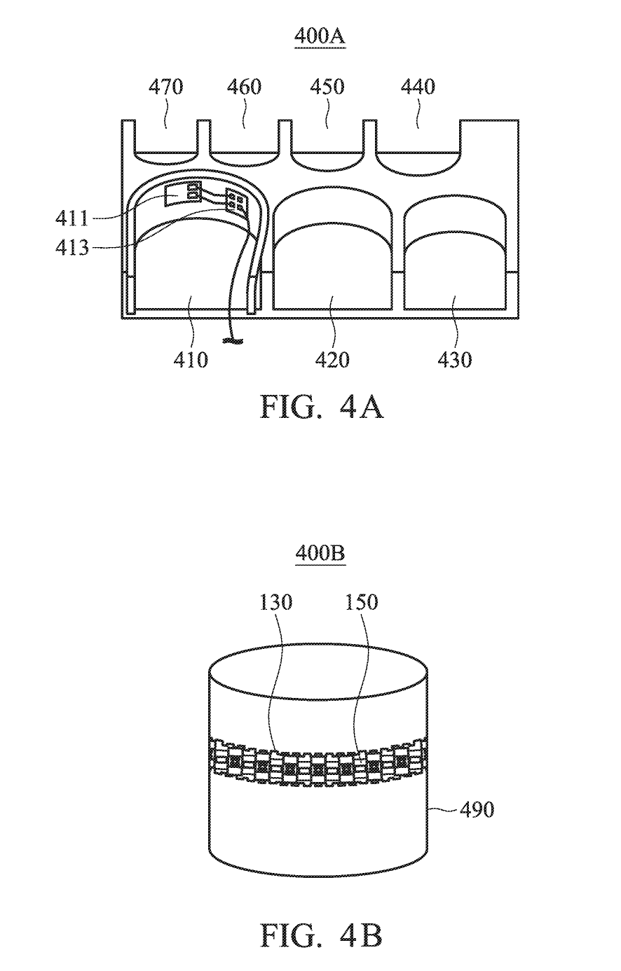

FIG. 4A shows a calibration module 400A for calibrating bend sensors according to some embodiments of the invention. The calibration module 400A may be a set of plastic molds that correspond to semicircles of different radiuses (semicircles 410 through 470). As shown, a bend sensor 411 is fit into the semicircle 410. Note that the reading provided by the bend sensor 411 may be transmitted to some circuitry (not shown) for further processing through the wired interconnection 413. Different radiuses correspond to bending a bend sensor to different angles (e.g. the semicircle 410 may correspond to a 30 degree bending). Of course, other types of curvatures, other than semicircles, may be exploited for doing calibration. Due to fabrication process non-ideality, two bend sensors may generate different values even if the two bend sensors undergo exactly the same deformation. For example, when the bend sensor 150-1 and the bend sensor 150-2 are fit to the semicircle 410 one after another, the respective value V1 generated by the bend sensor 150-1 may be different from the respective value V2 generated by the bend sensor 150-2. This variation among bend sensors 150 suggests the necessity of calibration before using the bend sensors 150 to estimate the shape of the strip substrate 130.

To do calibration, each of the bend sensors 150 may be fit into the semicircle 410 and record the respective value obtained by each of the bend sensors as a first group of reference values. For example, there will be 11 reference values in the first group if there are 11 bend sensors. These 11 reference values record how a 30-degree deformation actually impacts the reading reported by each of the bend sensors 150 and therefore can be used for obtaining tracked deformation of the deformable object 110. With these reference values, it would be known during construction of the shape of the strip substrate 130 that both bend sensors 150-1 and 150-2 are bent by 30 degrees if the bend sensor 150-1 generates a value V1 (e.g. a resistance value) and the bend sensor 150-2 generates a value V2. Repeating the same by fitting the bend sensors 150 into other semicircles (i.e. semicircles 420 through 470), there will be 7 groups of reference values collected. So, according to one embodiment, the shape-sensing system 100 may further comprise the calibration module 400; the calibration module 400 comprises N curves with each curve having a predefined curvature, wherein one group of reference values used to calibrate the respective values for obtaining tracked deformation of the deformable object are generated by fitting the plurality of bend sensors 150 into one of the N curves.

FIG. 4B illustrates another calibration module 400B according to another embodiment. The calibration module 400B comprises a cylinder 490, to which the strip substrate 130 (together with the bend sensors 150) is attached. As mentioned earlier, even though each of the bend sensors 150 is bent to the same degree, the readings generated by the bend sensors 150 may be different from each other; and these readings can be recorded for calibration through an analogous approach as described with respect to FIG. 4A.

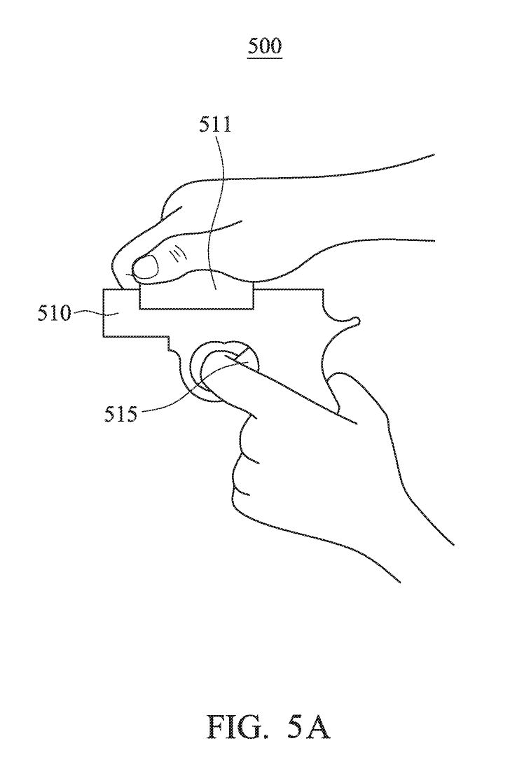

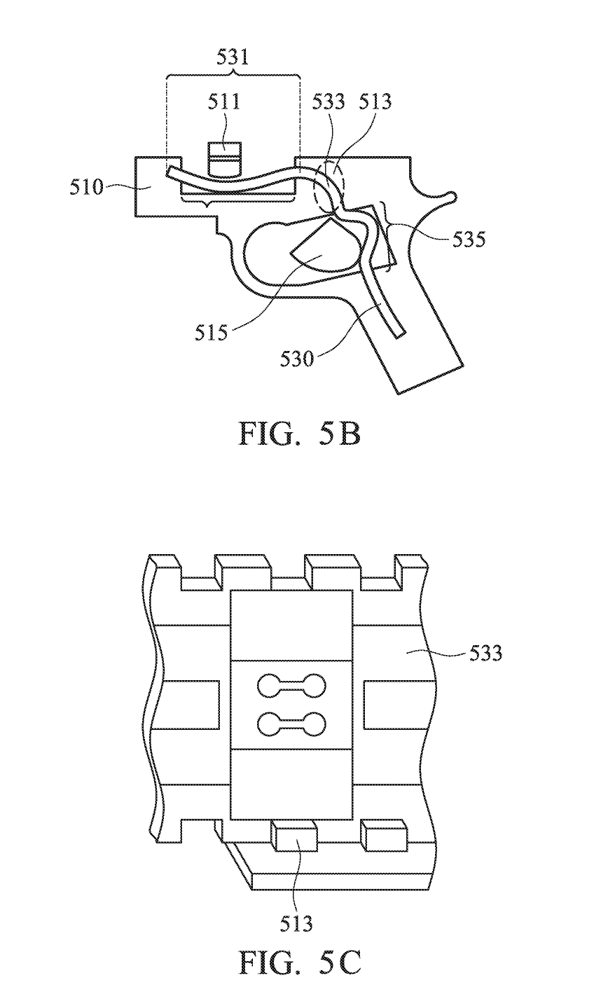

FIGS. 5A, 5B and 5C show a shape-sensing system according to another embodiment of the invention. Referring to FIGS. 5A and 5B, the shape-sensing system 500 comprises a deformable object 510, a strip substrate 530, and a plurality of bend sensors 550 (not explicitly drawn). Each of the components of the shape-sensing system 500 can be analogously understood as those described pertaining to FIGS. 1A and 1B. By way of example, not limitation, the deformable object 510 shown is a pistol.

As shown in FIGS. 5A and 5B, the deformable object 510 has a first movable part 511 (i.e. a slider) and a first portion 531 of the strip substrate 530 deforms when a force is exerted on the first movable part 511. In other words, when a user pulls or pushes the slider the first portion 531 of the strip substrate 530 deforms accordingly. Different deformations of the first portion 531 indicate the movement of the first movable part. Besides, the deformable object 510 further comprises a securing unit 513 that is configured to secure a third portion 533 of the strip substrate 530 when the first portion 531 of the strip substrate deforms. That is, when the user moves the first movable part 511 forward or backward, only the first portion 531 of the strip substrate 530 deforms because other portions of the strip substrate are insensitive to the force being applied to the first movable part 511 with the presence of the securing unit 513 (that keeps the third portion 533 fixed in position). The deformable object 510 may further comprise a second movable part 515 (i.e. a trigger) and a second portion 535 of the strip substrate 530 deforms when another force is exerted on the second movable part 515. With the securing unit 513 “locking” the third portion 533 of the strip substrate 530, when a first force is exerted on the first movable part 511 and a second force is exerted on the second movable part 515 simultaneously, deformation of the first portion 531 of the strip substrate 530 is insensitive to the second force. That is, the deformation of the first portion 531 of the strip substrate 530 basically results solely from the first force. As such, the user's pressing the trigger does not affect deformation of the first portion 531 of the strip substrate 530 and the deformation of the first portion 531 may purely reflect user operations towards the slider.

FIG. 5C shows a magnified view around the securing unit 513 and the third portion 533 of the strip substrate 530. In order to secure the third portion 533 of the strip substrate 530 well, an edge of the third portion 533 of the strip substrate 530 may have a particular shape that is suitable for being secured by the securing unit 513. As shown here, the edge of the third portion 533 is designed to have a gear shape to match the shape of the securing unit 513 so that the third portion 533 may be tightly locked.

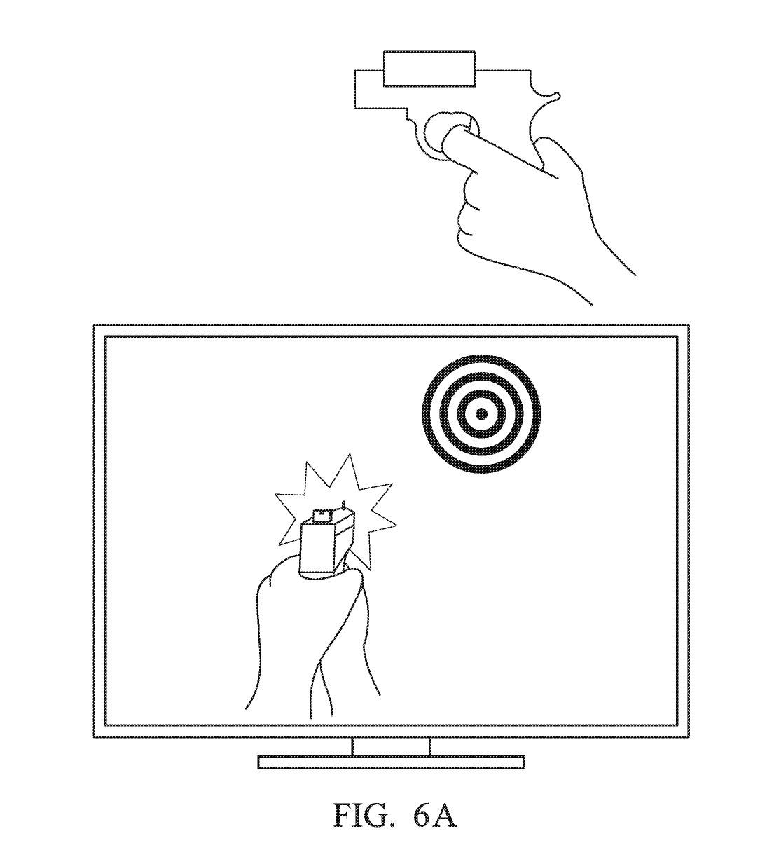

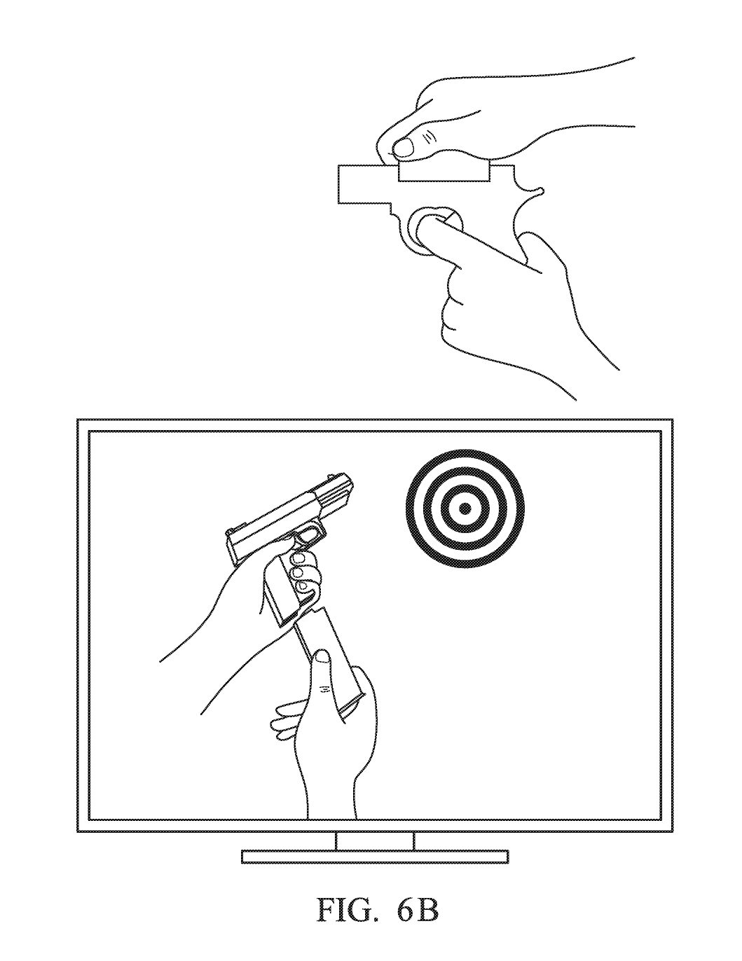

Deformations of different portions of the strip substrate 530 in response to different manipulations of the deformable object 510 by a user makes interactive application possible. FIGS. 6A and 6B illustrate a gaming application of the shape-sensing system 500 according to some embodiments. The gaming may be a first-person-shooter game, in which a user slides a slider to reload bullets and pulling a trigger to shoot. FIG. 6A shows that when the user pulls the trigger 515, the screen shows a gun firing. This is because as the trigger 515 is pulled, the second portion 535 of the strip substrate 530 deforms in a particular manner. Such deformation can be detected by processing respective values generated by the bend sensors 550; and once this particular deformation is detected, a processor may generate corresponding signals to guide the screen displaying the gun firing. Likewise, when the user slides the slider 511, virtual bullets are reloaded as shown in FIG. 6B.

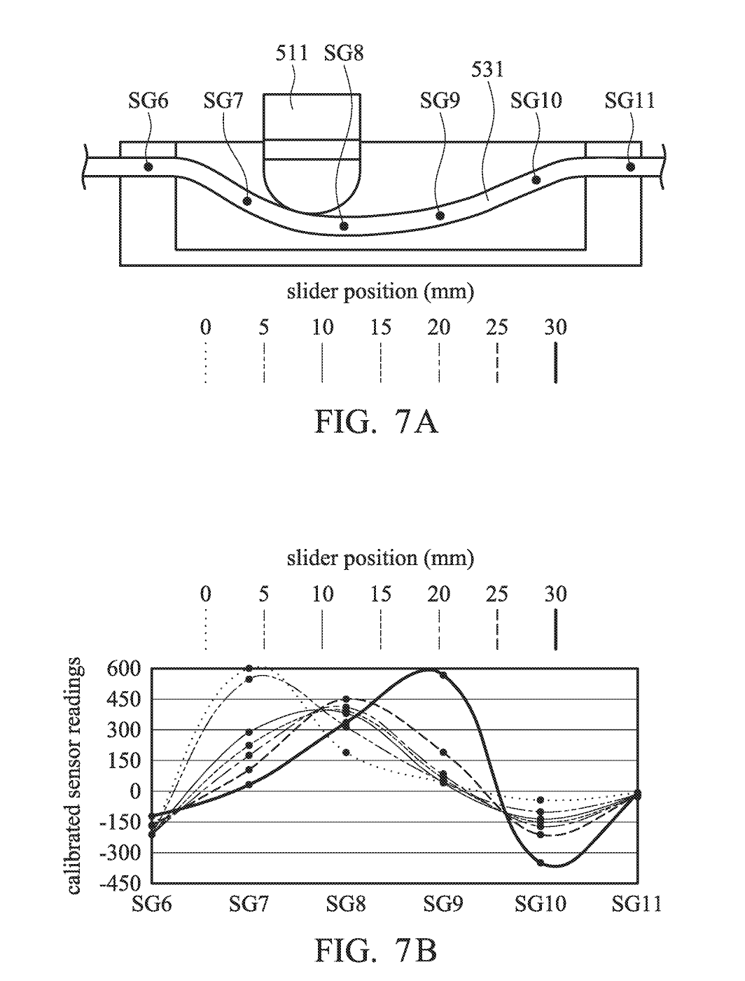

FIG. 7A shows an enlarged view of the slider 511 and the first portion 531 of the strip substrate 530. There are 6 bend sensors in FIG. 7A and, more specifically, the 6 bend sensors are strain gauges (denoted as SG6 through SG11). In FIG. 7A, the slider 511 is located near a slider position of 10 mm. FIG. 7B shows readings collected from the 6 strain gauges SG6 through SG11 as the position of the slider 511 changes. Such information enables the detection of the slider's position, which in turn may be used to determine a particular user operation with respect to the slider 511. As the slider 511 moves near both ends (i.e. toward strain gauge SG6 or SG11), the readings from the strain gauge SG7 or SG10 become relatively high because the internal structure of the deformable object 510 sharply bends the first portion 531 nearby the strain gauge G7 or SG10. However, the bending does not affect the readings from the strain gauge SG11 a lot. The reading from strain gauge SG11 remains around 0 through the movement of the slider 511, indicating that the securing unit 513 works as desired.

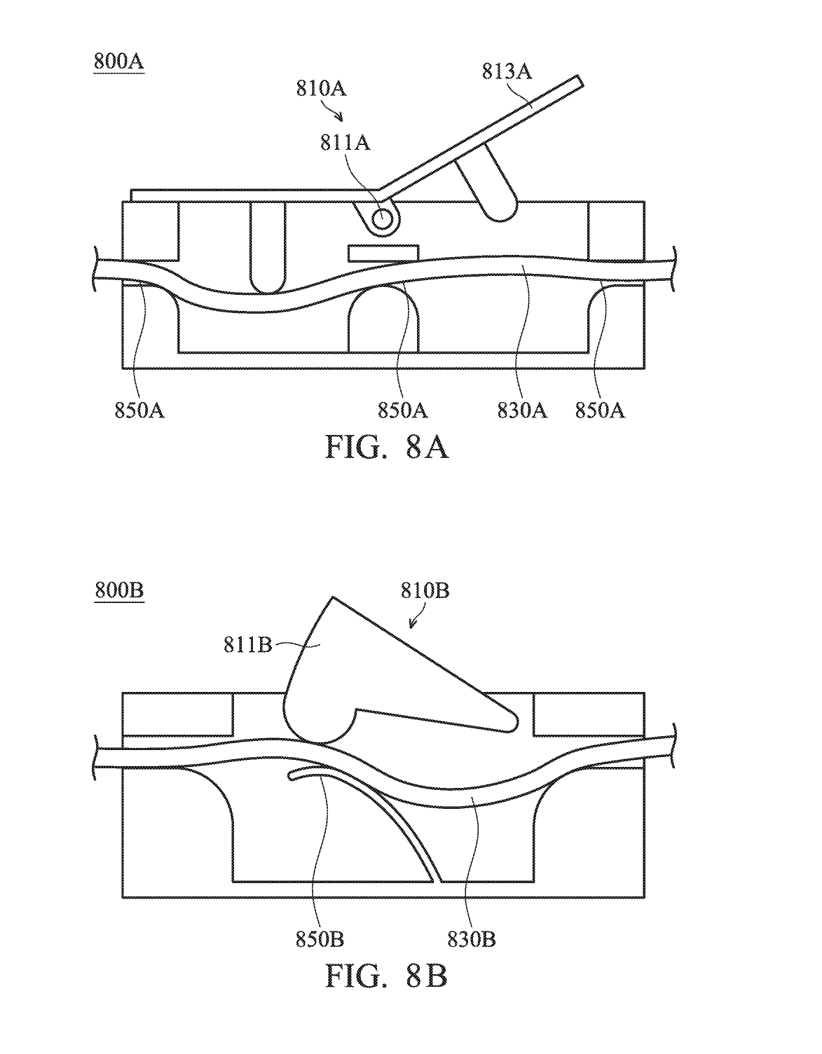

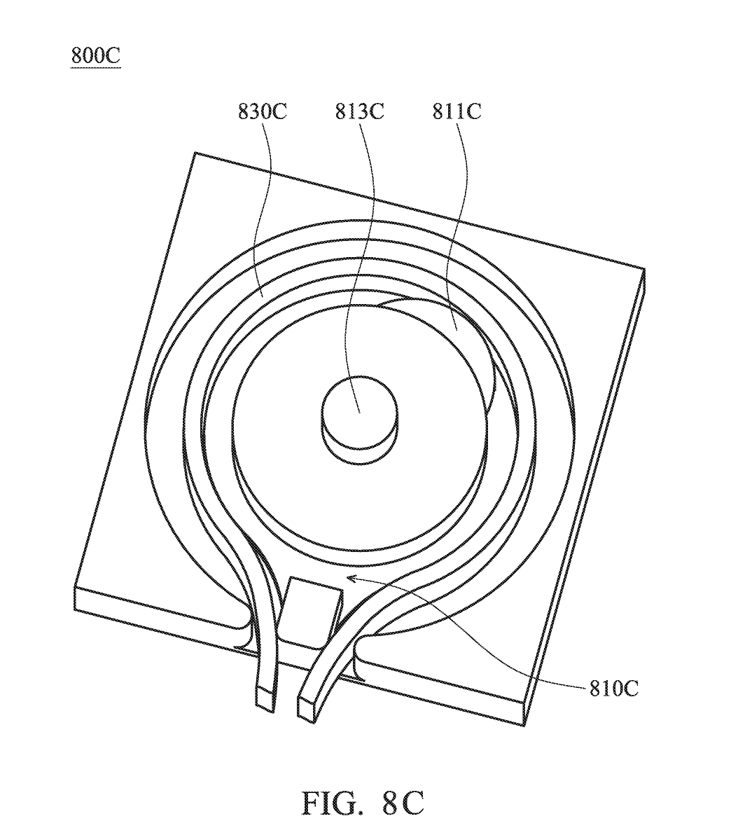

FIGS. 8A through 8C shows alternative shape-sensing system designs according to some other embodiments of the invention. The structure shown in each figure focuses on the movement of a movable part (i.e. 810A, 810B, or 810C; referred to hereinafter as a “widget”) and deformation of a strip substrate (i.e. 830A, 830B, or 830C). Basic operations of these shape-sensing systems can be similarly understood with respect to descriptions regarding FIGS. 7A and 7B. Referring to FIG. 8A, the widget 810A functions as a lever with a pivot 811A at its center. If the lifted part 813A is pressed down, the strip substrate 830A will be bent into another shape, which indicates that the widget 810A changes its configuration. Note that, for installing the strip substrate 830A into the shape-sensing system 800A, one or more openings 850A are implemented for the strip substrate 830A to pass through. With the openings 850A, not only can the strip substrate 830A be easily installed but it can also be secured.

Referring to FIG. 8B, the widget 810B is shown to function as a button. When the user presses the widget 810B down (by pressing down the left part 811B of the widget 810B), deformation of the strip substrate 830B indicates a button-press operation. When the user releases the widget 810B so that the left part 811B goes up, the shape of the strip substrate 830B would be restored to its original shape before the button-press operation. For example, the strip substrate 830B has a first shape before the user presses down the widget 810B (while the widget 810B is in a first configuration). After the user presses the widget 810B down (so that the widget 810B is in a second configuration), the strip substrate 830B will be bent to bear a second shape. When the user later releases the widget 810B, the strip substrate 830B returns to the first shape as the widget 810B moves back to the first configuration. Note that, for the shape-sensing system 800B, the shape-restoring characteristics of the strip substrate 830B are realized with the presence of the spring 850B.

In addition to functionality of slider, switch, and button, a knob widget 810C can be likewise designed as shown in FIG. 8C. When a user rotates the knob widget 810C, a change of the angle of the knob can be detected based on the deformation of the strip substrate 830C. More specifically, the knob widget 810C comprises a horizontal bulge 811C and a vertical bulge 813C. As the user moves the knob widget 810C by rotating the vertical bulge 813C either clockwise or counter-clockwise, the horizontal bulge 811C changes its location. As such, the portion of the strip substrate 830C that is bent by the horizontal bulge 811C changes as well so that changes of the deformation of the strip substrate 830C can be used to indicate the degree of rotation of the knob widget 810C.

It is to be understood that the elements and features recited in the appended claims may be combined in different ways to produce new claims that likewise fall within the scope of the invention. Thus, whereas the dependent claims appended below depend from only a single independent or dependent claim, it is to be understood that these dependent claims may, alternatively, be made to depend in the alternative from any preceding or following claim, and that such new combinations are to be understood as forming a part of the specification of the invention.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A shape-sensing system, comprising:
a deformable object, configured to deform when a first force is exerted on the deformable object;
a strip substrate, wherein the strip substrate is installed in the shape-sensing system such that the strip substrate deforms in response to deformation of the deformable object; and
a plurality of bend sensors, fixedly attached to a surface of the strip substrate at different respective locations, and configured to generate respective values in response to deformation of the strip substrate,
wherein the respective values are used for obtaining tracked deformation of the deformable object.

2. The shape-sensing system as claimed in claim 1, wherein the deformable object is a hand-held device.

3. The shape-sensing system as claimed in claim 1, wherein the first force is indirectly exerted on the strip substrate through the deformable object.

4. The shape-sensing system as claimed in claim 1, wherein one of the respective values is indicative of a local curvature of the strip substrate associated with one of the bend sensors.

5. The shape-sensing system as claimed in claim 1, wherein the deformable object has a body cavity and the strip substrate is placed within the body cavity so that deformation of the deformable object can be represented by deformation of the strip substrate.

6. The shape-sensing system as claimed in claim 5, further comprising:
a malleable material attached to the strip substrate to provide the strip substrate with a shape-retaining capability.

7. The shape-sensing system as claimed in claim 1, wherein the deformable object comprises a first movable part, and a first portion of the strip substrate deforms when the first force is exerted on the first movable part.

8. The shape-sensing system as claimed in claim 7, wherein the deformable object further comprises a securing unit, configured to secure a third portion of the strip substrate when the first portion of the strip substrate deforms.

9. The shape-sensing system as claimed in claim 8, wherein the deformable object further comprises a second movable part and a second portion of the strip substrate deforms when a second force is exerted on the second movable part.

10. The shape-sensing system as claimed in claim 9, wherein when the first force is exerted on the first movable part and the second force is exerted on the second movable part simultaneously, deformation of the first portion of the strip substrate is insensitive to the second force as the third portion of the strip substrate is secured.

11. The shape-sensing system as claimed in claim 8, wherein an edge of the third portion of the strip substrate has a particular shape that is suitable for being secured by the securing unit.

12. The shape-sensing system as claimed in claim 1, wherein one of the bend sensors is a dummy sensor that does not deform in response to deformation of the deformable object.

13. The shape-sensing system as claimed in claim 12, wherein one of the respective values generated by the dummy sensor is used for compensating for environmental effects on other respective values.

14. The shape-sensing system as claimed in claim 1, further comprising:
a processing circuit, configured for obtaining the tracked deformation of the deformable object according to the respective values, wherein the processing circuit receives the respective values wired or wirelessly.

15. The shape-sensing system as claimed in claim 14, wherein the processing circuit transmits the tracked deformation of the deformable object to an electronic device as an input to the electronic device.

16. The shape-sensing system as claimed in claim 15, wherein images corresponding to the tracked deformation of the deformable object is displayed via a display unit of the electronic device.

17. The shape-sensing system as claimed in claim 14, wherein the processing circuit obtains the tracked deformation of the deformable object by:
estimating shape of the strip substrate according to the respective values; and
obtaining the tracked deformation of the deformable object according to an estimated shape of the strip substrate.

18. The shape-sensing system as claimed in claim 17, wherein one of the respective values corresponds to a curvature crossing a plurality of points of a specific segment of the strip substrate and shape of the strip substrate is estimated by interpolating the plurality of points associated with different curvatures corresponding to the respective values.

19. The shape-sensing system as claimed in claim 1, further comprising:
an inertial measurement unit, attached to an end of the strip substrate, configured to detect 3-dimensional (3D) orientation of the strip substrate.

20. The shape-sensing system as claimed in claim 1, further comprising:
a calibration module, comprising N curves with each curve having a predefined curvature, wherein one group of reference values used to calibrate the respective values for obtaining tracked deformation of the deformable object are generated by the plurality of bend sensors when the strip substrate is fit into one of the N curves, wherein N is a positive integer.

21. The shape-sensing system as claimed in claim 1, wherein the deformable object comprises one or more openings and the strip substrate passes through the one or more openings so as to be installed in the shape-sensing system.

22. The shape-sensing system as claimed in claim 7, wherein when the first movable part moves from a first configuration back to the first configuration via a second configuration, the strip substrate deforms from a first shape back to the first shape via a second shape.
